(19) United States
(12) Patent Application Publication
(10) Pub. No.: US 2006/0213011 A1
(43) Pub. Date: Sep. 28, 2006

(54) Patient restraining apparatus

(76) Inventors: John E. McLoughlin, Grove, NY (US); Neocles G. Athanasiades, Setauket, NY (US); Toh K. Meng, Hauppauge, NY (US)

Correspondence Address: Frank L. Hart;Attorney at Law, 8911 S. 73rd East Ave., Tulsa, OK, 74133, US

(21) Appl. No.: 11/088,099

(22) Filed: Mar. 24, 2005

(51) Int. Cl. A61G 1/00; A61G 1/044

(52) U.S. Cl. 5/628; 5/625; 128/870

(57) ABSTRACT

A covering blanket has a plurality of straps for securing a patient against movement. The straps are of the hook and eye type and are connectable to a back board, stretcher or other apparatus. A stabilizing sheet with stabilizing rods can be connected to the covering blanket and define a means for transporting a patient.

### BACKGROUND OF THE INVENTION

1. Field of the Invention

The subject invention relates to apparatus for restraining a patient.

More particularly, the subject invention relates to apparatus for restraining a patient and transporting the patient.

2. Description of Related Art Including Information Disclosed Under 37 CFR 1.97 and 1.98

In dealing with trauma cases, the patient is sometimes in serious pain and is not capable of laying quietly. They must be restrained to prevent them from injuring themselves further by falling off of a stretcher or from violent movement of a body part.

Heretofore, straps were used to secure the patient, but the straps did not cover substantially the entire body and therefore the support provided was minimal.

The object of this invention is to provide apparatus which covers substantially the entire body and supports and maintains the body. It also is constructed to be associated with a stabilizing sheet and associated stabilizing bars which permits the apparatus to be used to carry a patient.

### BRIEF SUMMARY OF THE INVENTION

An apparatus is provided for restraining a patient. The apparatus has an elongated covering blanket having a longitudinal axis, a length and a plurality of opening spaced apart along the length. The covering blank has a top and bottom surface and first and second end portions and first and second side portions. First and second securing straps are connected to the first end portion of the covering blanket. A securing strap is connected to the second end of the covering blanket. A plurality of side securing straps are connected at spaced apart locations along the longitudinal axis of the covering blanket. Each side securing strap extends transversely outwardly from respective adjacent sides of the covering blanket. A plurality of flexible loop type handles are each connected to respective sides of the covering blanket at locations between side securing straps. The securing straps are formed of hook and eye type connecting material. Each strap is connected to the blanket and is extendable through a respective back board opening with the strap ends connectable on themselves.

### BRIEF DESCRIPTION OF THE SEVERAL VIEWS OF THE DRAWING(S)

FIG. 1 is a top plan view of the elongated covering blanket of this invention;

FIG. 2 is a bottom plan view of the elongated covering blanket of this invention;

FIG. 3 is a plan view of an example back board upon which the apparatus of this invention can be used;

FIG. 4 is a plan view of a stabilizing sheet which is an accessory for the apparatus of this invention; and

FIG. 5 is an end view taken along lines V-V of FIG. 4

### DETAILED DESCRIPTION OF THE INVENTION

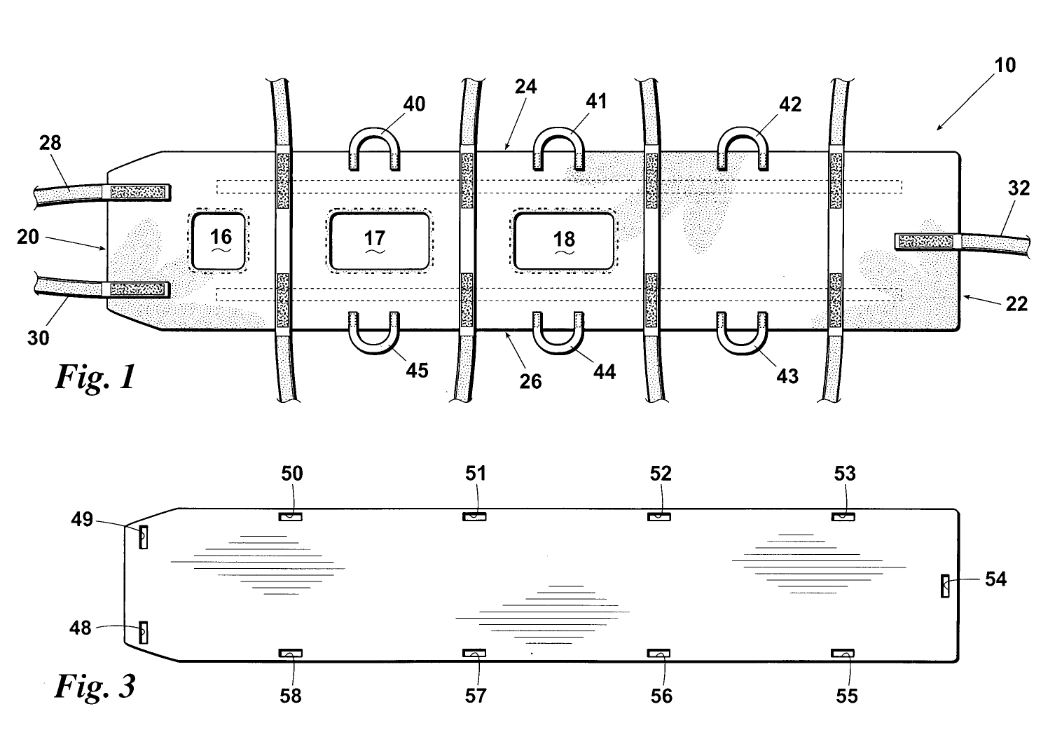

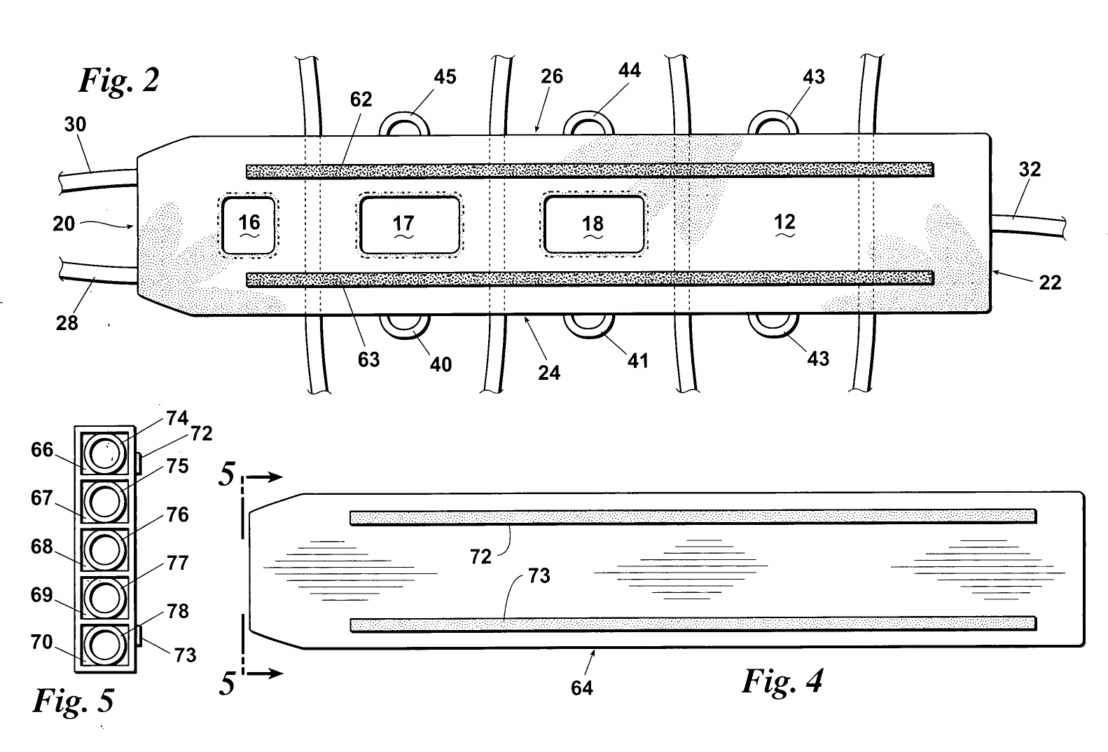

FIGS. 1 and 2 show the respective top and bottom surfaces 10,12 of an elongated covering blanket 14. The covering blanket 14 has a longitudinal axis, a length, and a plurality of openings 16-18 spaced apart along the length. The covering blanket 14 also has first and second end portions 30,22 and first and second side portions 24,26.

First and second shoulder securing straps 28,30 are connected to the first end portion 20 of the covering blanket 14 at locations spaced one from the other. A securing strap 32 is connected to the second end portion of the covering blanket 14.

A plurality of side securing straps 34-37 are connected at spaced apart locations along the longitudinal axis of the covering blanket 14. In the preferred embodiment shown, each strap 34-37 extends transversely outwardly from respective adjacent sides of the covering blanket 14 and is a unitary piece in order to strengthen the blanket 14. These straps can however be separate straps extending outwardly from a respective blanket side, but not be unitary. Also, the straps 34-37 are relatively long in order to accommodate an obese patient.

A plurality of flexible loop type handles 40-45 are each connected to a respective side portion 24,26 of the blanket 14 and are each located between adjacent side securing straps 34-37. One part of a hook and eye type material is connected to the bottom surface 12 of the apparatus as strips 62-63 each extending along a respective first and second side portion 24,26 of said apparatus.

The securing straps 32 and 34-37 are formed of hook and eye type material and are each of a size sufficient for being extendable through a respective opening 48-59 of an example back board 46 of FIG. 3. The securing straps 32 and 34-37 are pulled through the openings 48-59 and then doubled back and connected to themselves. The patient is therefore between the back board 62 and the blanket and the straps 32 and 34-37 are pulled sufficiently tight to place forces on the patient and stabilize movement. The straps 32 and 34-37 can be positioned about a railing or bar in different embodiments of the back board or a stretcher.

The openings 16-18 extend through the covering blanket 14 and are at selected positions relative to a body being restrained by the blanket 14. The openings provide access for paramedical personnel to work on the patient and run diagnostic tests on the patient while being transported to a hospital, for example.

Referring to FIGS. 2, 4 and 5, an elongated stabilizing sheet 64 is provided which has a longitudinal axis and a plurality of pockets 66-70 extending along the longitudinal axis at spaced apart locations. The other matching and connecting part of the hook and eye type material is provided in two strips 72,73 and is connected to the stabilizing sheet 64 at locations engageable with the hook and eye strips 62,63.

Referring to FIG. 5, a plurality of stabilizing rods 74-78 are each positionable in a respective pocket 66-70 of the stabilizing sheet 64. The rods 46 can be formed of organic plastic, or metal or wood, preferably they are formed of polyethylene. It should be noted that the stabilizing sheet 64 is of substantially the same dimensions as the elongated covering blanket 14. By this construction, an individual can be positioned between the covering blanket and the stabilizing sheet 64 and the handles 40-45 can be used to lift the secured patient and transport him without a back board 46 or stretcher.

It should be understood that various other securing straps can be attached to the covering blanket 14 without departing from this invention. Such additional securing straps can be supplied for selectively securing various body parts. For example, straps can be provided for securing head blocks to the blanket. legs and arms can also be selectively restrained by providing other securing straps.

Other aspects, objects, and advantages will become apparent by a study of the drawings, the specification and the appended claims.

1. (canceled)

2. (canceled)

3. An apparatus, as set forth in claim 8, wherein the reinforcing rods are each formed for organic plastic.

4. An apparatus, as set forth in claim 8, wherein the reinforcing rods are each formed of metal.

5. An apparatus, as set forth in claim 8, wherein the reinforcing rods are each formed of wood.

6. An apparatus, as set forth in claim 8, wherein the elongated stabilizing sheet is of substantially the same dimensions as the elongated blanket.

7. A apparatus for restraining a patient, comprising:
an elongated blanket having a longitudinal axis, a length, a plurality of openings spaced apart along said length, top and bottom surfaces, first and second end portions, and first and second side portions, said blanket having reinforcing elements extending therethrough and said openings each being located spaced a substantially equal distance from said blanket side portions and each being of significant size relative to the size of the blanket;
first and second shoulder securing straps connected to the first end portion of the blanket;
a securing strap connected to the second end portion of the blanket;
a plurality of side securing straps connected at spaced apart locations along the longitudinal axis of the blanket, each side securing strap extending transversely outwardly from respective adjacent sides of the blanket;
a plurality of flexible loop type handles each being connected to respective side of the blanket at locations between side securing straps; and
said securing straps being formed of hook and eye type material each being connected to the top surface of the blanket and being extendable through a respective back board opening with the strap ends connectable on themselves.

8. An apparatus, as set forth in claim 7, including:
one part of a hook and eye type material connected to the bottom surface of the apparatus and extending along the first and second sides of said apparatus;
an elongated stabilizing sheet having a longitudinal axis, a plurality of pockets extending along the longitudinal axis at spaced apart locations, and the other part of the hook and eye type material connected to the stabilizing sheet at locations in matching and connecting engagement with said one part of hook and eye type material on said apparatus; and
a plurality of stabilizing rods each positionable in a respective pocket of the stabilizing sheet.
